(19) United States
(12) Patent Application Publication
(10) Pub. No.: US 2004/0234215 A1
(43) Pub. Date: Nov. 25, 2004

(54) Exterior installation of armored fiber optic cable

(76) Inventors: Jorge R. Serrano, Hickory, NC (US); Paul R. Baird, Hickory, NC (US)

Correspondence Address: CORNING CABLE SYSTEMS LLC, P O BOX 489, HICKORY, NC, 28603, US

(21) Appl. No.: 10/317,531

(22) Filed: May 23, 2003

(51) Int. Cl. G02B 6/44

(52) U.S. Cl. 385/100

(57) ABSTRACT

An armored fiber optic cable 10 can be installed in a channel 3, excavated in a roadway or other paved surface by a laying unit 1 including a cutting wheel 2. The armored fiber optic cable includes optical fibers 11 located within a cylindrical thermoplastic inner jacket 13. An armor layer or jacket 12 surrounds this inner jacket, and an outer barrier jacket 14 extends around this armor jacket. This armored fiber optic cable 10 need not be disposed in a tube or pipe, and mid-span access to the optical fibers 11 can be readily obtained by removing a section of the armored jacket 12. The armor jacket 12 can be joined to the inner jacket 13, fabricated from a thermoplastic material, to limit longitudinal contraction due to thermal contraction and bucking of the optical fibers 11.

### BACKGROUND OF THE INVENTION

This invention is related to the underground installation of fiber optic cables. It is related to a process for placing a cable in a channel, trench or groove that can be made in a paved surface and to apparatus for use in excavating the channel and laying the cable. This invention is also related to armored fiber optic cables and to an armored fiber optic cable that is suitable for outdoor and underground installation.

U.S. Pat. No. 6,371,691 disclosed an apparatus and method for introducing a fiber optic cable into a solid bed. A laying machine with a cutting wheel is used to cut a narrow channel having a width of 4 to 12 mm. and a depth of 50 to 100 mm. The channel is typically cut in a roadway or similar surface. A tubular fiber optic cable is laid in this channel. The optical fibers are either positioned within a tube, pipe or conduit prior to installation of into the channel, or the optical fibers are blown in an tube after the tube has been placed in the channel and filler materials inserted to close the channel. In either event, the tube is continuous making it difficult to subsequently access the optical fibers at a mid-span location.

The instant invention simplifies mid-span access by positioning an armored cable into the channel. The armor provides structural protection for the optical fibers, but the armor can be more easily removed than a tube, pipe or conduit surrounding the fiber optic cable. Although armored fiber optic cable is commonly used for intrabuilding routing within riser shafts, in wiring closets and to workstations, this type of cable is not believed to have been previously used for underground installation as in the present invention.

### SUMMARY OF THE INVENTION

A process of laying an underground fiber optic cable begins with the progressive excavation of a channel in pavement. Subsequently an armored fiber optic cable is progressively laid in this channel. The armored fiber optic cable includes an armor jacket wrapped around optical fibers. The armored fiber optic cable also includes a barrier layer or jacket adjacent to the armored jacket. Then a water tight filler material is progressively inserted into the channel, over the armored fiber optic cable to at least partially fill the channel. At a later time, mid-span access to optical fibers in the fiber optic cable can be gained by removing an intermediate section of the armored layer to gain access to the optical fibers.

The resulting underground fiber optic cable installation thus includes a fiber optic cable installed in a channel cut in pavement. The fiber optic cable is covered by a filler material in the channel. This fiber optic cable includes optical fibers surrounded by an armored jacket wrapped around the optical fibers and separating the optical fibers from the pavement and from the filler material.

In one embodiment the metal jacket surrounding the inner jacket, which can be an interlocking armor jacket, has a lower coefficient of thermal expansion than the inner jacket surrounding the optical fibers. The metal jacket is longitudinally joined to the inner jacket to constrain longitudinal expansion and contraction of the inner jacket due to temperature variations. Deformation of the optical fibers due to longitudinal expansion and contraction of the inner jacket will therefore not be as severe.

### BRIEF DESCRIPTION OF THE DRAWINGS

FIG. 1 is a view showing the progressive excavation of a channel in a paved surface, such as a roadway, followed by the progressive installation of an armored fiber optic cable in the channel.

FIG. 2 is a cross sectional view of an armored fiber optic cable installed in a channel and covered by filling materials.

FIG. 3 is a view of an armored fiber optic cable of the type that can be installed in an exterior, underground location as shown in FIGS. 1 and 2.

FIG. 4 is a partial cross sectional view showing the armored layer of the armored fiber optic cable joined to an inner jacket in one embodiment of this invention.

FIG. 5 is a sectional view of the corrugated armor forming the armored layer in the fiber optic cable shown in FIG. 3.

FIG. 6 is a view showing removal of the outer jacket of the armored fiber optic cable shown in FIG. 3 to gain midspan access to the optical fibers in the cable.

FIG. 7 is a view showing the manner in which the armored cable can be removed at a midspan location after the outer jacket has been removed as shown in FIG. 6.

### DETAILED DESCRIPTION OF THE PREFERRED EMBODIMENT

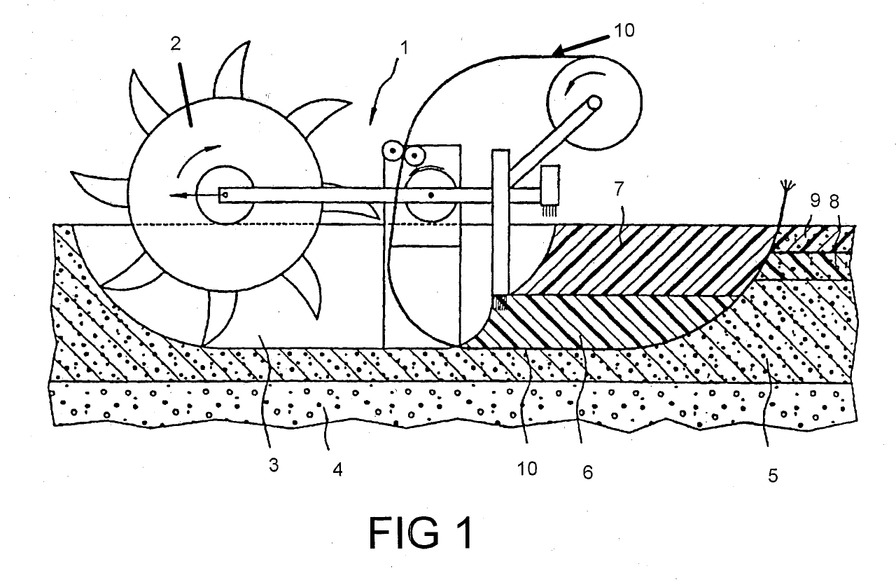

FIG. 1 shows the operation of progressively laying an armored fiber optic cable 10, suitable for outdoor or exterior installation, in pavement using a laying unit 1 of the type described in U.S. Pat. No. 6,371,691, incorporated herein by reference. The laying unit 1 includes a rotating cutting wheel 2 that progressively excavates a narrow channel 3 having straight vertical walls into pavement 5 or a similar material. Of course a similar operation could be performed to install an armored fiber optic cable 10 in other underground locations, such as directly under or through the earth.

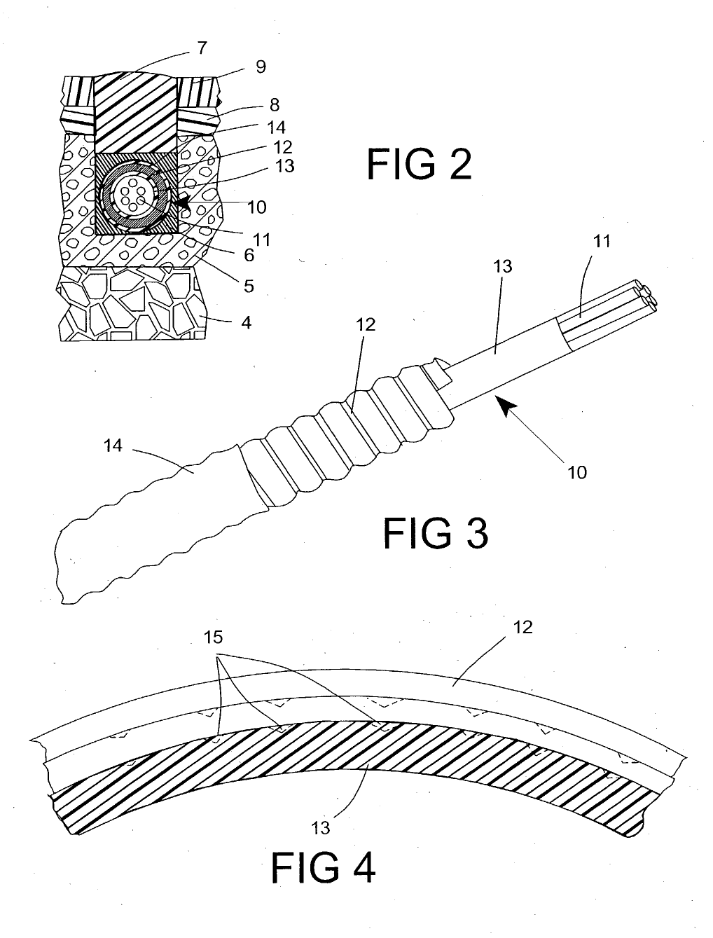

The armored fiber optic cable 10 is continuously extracted from a cylindrical drum and is guided into place so that it can be directly laid progressively into the channel 3, immediately after the channel 3 has been excavated or cut. There is no need to first install the armored fiber optic cable 10 in a protective tube or conduit prior to progressive placement of the armored fiber optic cable 10 into the channel 3. After the armored fiber optic cable 10 has been laid in the channel 3, filler materials can then be progressively added to surround the cable 10. In the installation procedure depicted in FIGS. 1 and 2, lower portions of the channel 3 are first filled with a foam material 6. Subsequently, a water-tight filler material 7, such as bitumen, is added on top of the foam filler 6. It should be understood that only a single filler material 7, such as bitumen, could also be employed, in which case the water-tight bitumen filler material 7 would completely surround the armored fiber optic cable 10 in the channel 3.

FIGS. 1 and 2 specifically demonstrate how an armored fiber optic cable 10 could be installed in a roadway, which could include an anti-frost layer 4 generally comprising crushed stone. A base course 5 is shown arranged on the anti-frost layer 4. A binder course 8 is shown on top of the base course 5, and a surface course 9 is deposited thereon to form the complete roadway or pavement in which the channel 3 is to be cut. Each of these courses is at least partially removed to form the channel 3, which is then completely filled after installation of the armored fiber optic cable 10 to repair the paved roadway. All of these filler materials are progressively introduced into the channel immediately after the armored fiber optic cable has been inserted therein, and in the same manner as described in more detail in U.S. Pat. No. 6,371,691, the complete installation of an armored fiber optic cable 10 can be rapidly completed. However, this installation is accomplished without the necessity of a tube or conduit for encasing the armored fiber optic cable 10.

The armored fiber optic cable 10 shown in FIG. 3 can be used in the underground installation shown in FIGS. 1 and 2. Armored fiber optic cable 10 includes a plurality of optical fibers 11. In the instant invention, six optical fibers 11 are shown, although it should be understood, that this invention is not limited to a fiber optic cable containing any specific number of optical fibers. For instance, this invention could also be applicable at least for armored fiber optic cables having from two (2) to one hundred forty four (144) optical fibers. In the preferred embodiment, the optical fibers 11 can be buffered fibers and strength members, not shown, would typically be included with the optical fibers 11, as in conventional fiber optic cables.

The optical fibers 11 are surrounded by a thermoplastic inner jacket or central tube 13. This inner jacket of central tube 13 may also contain a waterblocking gel to prevent water migration if desired as well as yams or strength members of typical construction. Inner jacket 13 extends longitudinally along the entire length of the armored fiber optic cable 10. The embodiment of FIG. 3 shows only a single central tube or inner jacket 13. However, in other embodiments, multiple buffer tubes or subunit jackets can be surrounded by inner jacket 13. Multiple buffer tubes can be used for higher fiber count cables, and the buffer tubes can be installed longitudinally, helically or S-Z stranded. Preferably however, multiple buffer tubes would still be surrounded by an inner jacket 13, which would form a central core in which all of the optical fibers 11 would be located. In the preferred embodiment of this invention, the inner jacket 13 would be extruded from a material, such as polyvinyl chloride, and would have a thickness of approximately 1.5 mm.

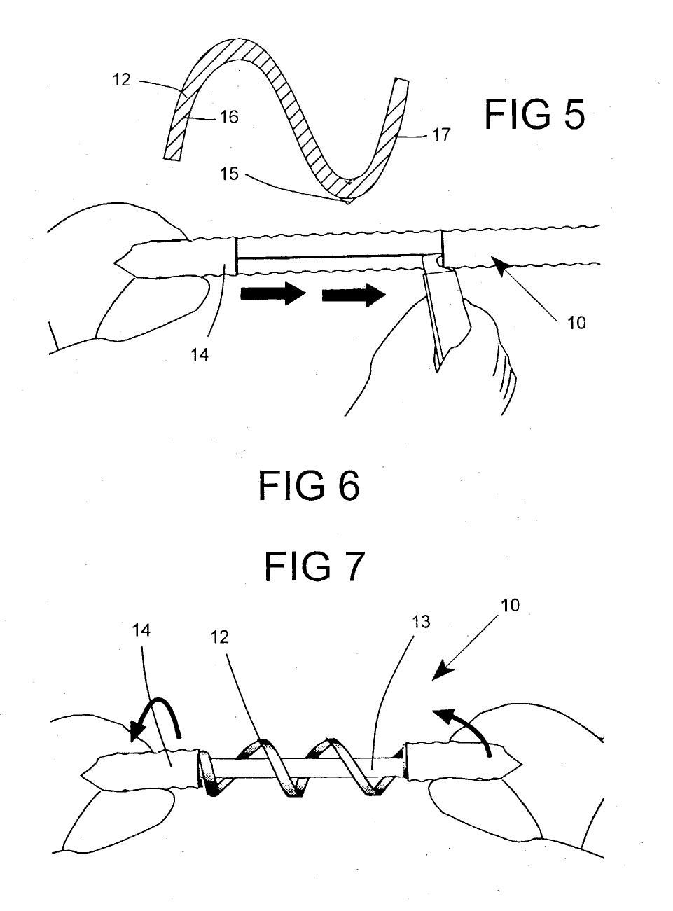

The inner jacket 13 is surrounded by an armored layer or jacket 12, which in the preferred embodiment is formed by an interlocking, corrugated metal tape. This armored jacket 12 provides crush-resistance and cable protection. This armored jacket 12 would typically be fabricated from an aluminum or galvanized steel metal tape that would be wrapped around the inner jacket 13 and the optical fibers 11 contained therein. As shown in FIG. 5, the metal tape from which the armored jacket 12 is formed has an undulating or corrugated shape in which an outer section 16 is joined to an inner section 17. The outer section 16 is dimensioned to fit tightly over the smaller inner section 17 as the tape is helically wound to form the corrugated helical armor layer 12. In this manner the outer section 16 is interlocked to the inner section 17 of an adjoining portion of the metal tape so that the outer section continuously overlaps the inner section along the entire length of the armored layer or jacket 12.

Preferably the armored jacket 12 is joined, attached or bonded to the inner jacket 13 along the length of the fiber optic cable. By physically attaching the metal armored jacket 12 to the inner jacket 13, longitudinal contraction or expansion of the inner jacket 13 is restrained or constrained by the armored jacket 12 to which it is attached. Since the coefficient of thermal expansion of the thermoplastic inner jacket 13 is greater than the coefficient of expansion of the metal armored jacket 12, the inner jacket 13 would tend to longitudinally expand or contact at a greater rate in response to thermal changes that would be anticipated in a outdoor, underground installation. By joining the inner jacket 13 to the armored layer 12, this expansion and contraction could be limited. Longitudinal expansion and contraction would tend to result in lateral forces acting on the optical fibers 11, causing these fibers to bow or bend in a generally sinusoidal manner. Deformation of this type can result in signal attenuation, and by joining the inner jacket 13 to the armored jacket 12, potential, adverse deformation of the optical fibers 11 can be limited.

FIGS. 4 and 5 show one manner in which the armored jacket 12 can be attached or joined to the inner jacket 13. Projections or tangs 15 have been formed along the length of the inner armor section 17 at the innermost extent of the corrugated jacket. These projections 15 extend inwardly so that, as the armored jacket 12 is wrapped around the inner jacket 13, these projections would dig into cylindrical outer surface of the thermoplastic inner jacket 13 periodically along the entire length of the armored fiber optic cable 10. These projections 15 could be punched in the metal tape forming the armored layer 12, so that a recess would be located on the outer surface of the inner section 17, and the outward projection 15 would be formed on the outer surface. Since the outer section 16 of the corrugated metal tape would overlap the inner section 17, the recesses formed along the top surface of the inner section 17 would be covered by the overlapping outer section 16 of the metal tape when wrapped to form the corrugated metal jacket 12.

The projections 15 comprise only one means for physically attaching the armored jacket 12 to the inner jacket 13. In other embodiments, the armored jacket 12 could be adhesively bonded to the inner jacket 13. A waterproof tape could also be added between the inner jacket 13 and the armored layer or jacket 12. A waterproof tape with a double sided adhesive could also comprise the means for attaching the armored jacket 12 to the thermoplastic inner jacket 13. Alternatively projections 15 could penetrate the waterproof tape and extend into inner jacket 13 to join all three layers.

Although a corrugated, interlocking armored layer 12 is formed in this preferred embodiment, this invention is not limited to this type of armored layer. For example, the armored layer could be longitudinally applied such that the longitudinal edge sections of the armored layer overlap. In that alternate configuration, the strip used to form the armored layer would not be helically wrapped. In the overlapping, non helical armor, the metal strip could be flat or it could be corrugated, so that either a continuous, substantially round jacket could be formed, or a corrugated configuration could be formed. It should also be understood that the armored layer 12 need not necessarily be a metal jacket. A plastic armored layer could also be employed.

When a metal armored jacket 12 or an interlocking armored layer 12 is employed, an outer jacket 14 surrounds the armored jacket 12 and forms an outer, barrier layer of the armored fiber optic cable 10. This outer layer or jacket 14 serves as an outer environmental protective layer for the entire cable 10. Preferably this outer jacket 14 is formed from a rugged thermoplastic material. The outer jacket 14 also helps to retain the interlocking armor layers in engagement so that the helically wound metal tap will not unravel. However, when this continuous outer layer 14 is removed, the armor jacket 12 can also be unwrapped from the inner jacket 13 and the cable core to facilitate mid-span access to the optical fibers 11. As shown in FIG. 6, a mid-span section of the outer jacket 14 can be scored with a shape instrument, and then this intermediate section of the outer jacket 14 can be removed. When this intermediate section is removed, sections of the cable 12 on opposite sides can then be twisted in opposite directions as shown in FIG. 7. The interlocking, helically wound metal tape forming the armor 12 will then expand radially away from the inner jacket 13 and cable core. Intermediate sections of the armored jacket 12 can then be removed by merely cutting the tape. The projections 15 would disengage when the cable 19 is twisted in this manner. The inner jacket 13 can then be cut to expose the optical fibers 11, which themselves can be cut and reconnected by the installation of connectors or rerouted as desired. By using the armored fiber optic cable 10 of this invention, it is not necessary to install the cable in a tube, pipe or conduit, which first must be cut to gain access to the fiber optic cable surrounded by the continuous tubular covering. Thus mid-span access is greatly simplified.

The embodiment depicted herein contains the basic features to illustrate use of an armored fiber optic cable in an outdoor, underground location. Of course other embodiments of armored fiber optic cable can be employed. Other means may also be used to excavate a channel in which the armored fiber optic cable is laid. For instance, although quite advantageous, it will not be essential that the channel be cut in the manner depicted herein Therefore this invention is defined by the following claims and is not limited to the single representative embodiment depicted herein, nor to the alternatives that have been specifically discussed.

We claim:

1. A process for laying an underground fiber optic cable comprising the steps of:
progressively excavating a channel;
subsequently progressively laying an armored fiber optic cable in the channel, the armored fiber optic cable including an armor jacket wrapped around optical fibers, the armored fiber optic cable including a barrier layer adjacent to the armored jacket; and
subsequently progressively depositing a water tight filler material in the channel, over the armored fiber optic cable to at least partially fill the channel.

2. The process of claim 1 wherein the step of progressively excavating the channel comprises the step of cutting the channel in pavement.

3. The process of claim 1 wherein the barrier layer surrounds the armor jacket.

4. The process of claim 1 wherein the armored fiber optic cable includes an inner jacket between the optical fibers and the armor jacket.

5. The process of claim 2 wherein the armor jacket is formed from a steel tape wrapped around the optical fibers.

6. The process of claim 5 wherein the steel tape comprises a corrugated steel tape wrapped around the optical fibers to form a corrugated armor jacket.

7. The process of claim 1 wherein the filler material is deposited directly over and in contact with the armored fiber optic cable.

8. The process of claim 1 wherein the filler material comprises bitumen.

9. The process of claim 1 wherein the armored fiber optic cable is laid laterally directly into the channel, the barrier layer comprising a polymeric layer on the exterior of armor jacket that is exposed in the channel and in contact with the filler material subsequently added to the channel.

10. The process of claim 1 wherein the armored fiber optic cable in laid in the channel and is not positioned within a continuous exterior tube.

11. An underground fiber optic cable installation comprising a fiber optic cable installed in a channel cut in pavement, the fiber optic cable being covered by a filler material in the channel, wherein the fiber optic cable comprises a plurality of optical fibers surrounded by an armored jacket wrapped around the optical fibers and separating the optical fibers from the pavement and from the filler material.

12. The underground fiber optic cable installation of claim 11 wherein the armored jacket comprises a tape wrapped around the optical fibers so that portions of the tape overlap other portions of the tape to form a continuous jacket.

13. The underground fiber optic cable installation of claim 12 wherein the tape is helically wrapped around the optical fibers.

14. The underground fiber optic cable installation of claim 11 wherein an outer jacket surrounds the armored jacket, the outer jacket comprising a water tight barrier.

15. The underground fiber optic cable installation of claim 11 wherein the optical fibers are enclosed by an inner jacket between the optical fibers and the armored jacket.

16. The underground fiber optic cable installation of claim 15 wherein the inner jacket is attached to the armored jacket so that the armored jacket constrains the inner jacket against longitudinal expansion and contraction due to thermal effects.

17. The underground fiber optic cable installation wherein the armored jacket comprises an interlocking armored jacket.

18. The underground fiber optic cable installation of claim 11 wherein the armored jacket comprises tape that can be locally unwound to provide mid-span access to the optical fibers.

19. The underground fiber optic cable installation of claim 11 wherein the armored jacket is a metal jacket.

20. The underground fiber optic cable installation of claim 19 wherein the metal armored jacket is corrugated.

21. A process for positioning a fiber optic cable underground and outdoors and for subsequently gaining mid-span access to optical fibers in the fiber optic cable comprising the steps of:
excavating a channel;
laying a fiber optic cable including an armored layer surrounding the optical fibers in the channel; and
removing an intermediate section of the armored layer to gain access to the optical fibers.

22. The process of claim 21 including the step of filling the channel after the fiber optic cable is laid in the channel and of subsequently excavating the channel to gain mid-span access to the fiber optic cable and to the optical fibers surrounded by the armored layer.

23. The process of claim 21 wherein the armored layer comprises a metal tape wound to form the armored layer.

24. The process of claim 23 wherein the metal tape is corrugated and is helically wound around the optical fibers.

25. The process of claim 24 wherein the armored layer is encapsulated in an outer jacket.

26. The process of claim 25 wherein mid-span access is obtained by removing a section of the outer jacket surrounding the intermediate section of the armored layer and then rotating the armor to separate helically wound metal tape to gain mid-span access to the optical fibers.

27. The process of claim 25 wherein the armored layer and the outer jacket form a watertight barrier.

28. The process of claim 21 wherein the optical fibers are encapsulated by an inner jacket between the optical fibers and the armored layer.

29. The process of claim 28 wherein the armored layer is coupled to the inner jacket to restrain the inner jacket from longitudinally expanding due to thermal expansion and exerting lateral forces on the optical fibers.

30. The process of claim 21 wherein the channel is excavated by cutting a surface with a cutting wheel to form a channel with substantially vertical walls.

31. A fiber optic cable for use in outdoor applications comprising:
optical fibers;
an inner jacket surrounding the optical fibers; and
a metal jacket surrounding the inner jacket, the metal jacket being formed of a material having a lower coefficient of thermal expansion than the inner jacket, the metal jacket longitudinally joined to the inner jacket to constrain longitudinal expansion and contraction of the inner jacket due to temperature variations to limit deformation of the optical fibers due to longitudinal expansion and contraction of the innerjacket.

32. The fiber optic cable of claim 31 wherein the metal jacket comprises an armored jacket formed by a continuously wound tape.

33. The fiber optic cable of claim 32 where the tape is corrugated.

34. The fiber optic cable of claim 32 wherein the armored jacket includes projections extending inwardly into engagement with the inner jacket to grip the inner jacket and join the armored jacket to the inner jacket.

35. The fiber optic cable of claim 32 wherein the armored jacket is adhesively secured to the inner jacket.

36. The fiber optic cable of claim 31 wherein a waterproof tape is located between the inner jacket and the metal jacket, the inner jacket, the waterproof tape and the metal jacket being longitudinally joined together.
